(19) United States
(12) Patent Application Publication
(10) Pub. No.: US 2010/0119707 A1
(43) Pub. Date: May 13, 2010

(54) Protective coatings and coating methods for polymeric materials and composites

(75) Inventors: Derek Raybould, Denville, NJ (US); Margaret M. Floyd, Chandler, AZ (US)

Correspondence Address: HONEYWELL/IFL;Patent Services, 101 Columbia Road, P.O.Box 2245, Morristown, NJ, 07962-2245, US

(73) Assignee: Honeywell International, Inc.

(21) Appl. No.: 11/363,704

(22) Filed: Feb. 28, 2006

(51) Int. Cl. B05D 1/12

(52) U.S. Cl. 427/185

(57) ABSTRACT

A method for coating a polymeric or composite component surface with a wear and erosion resistance metal layer includes the step of cold gas-dynamic spraying a powder mixture onto the polymeric or composite component surface to form the wear and erosion resistance metal layer. The mixture may include at least one metal powder and at least one hard particle powder.

### TECHNICAL FIELD

The present invention relates to methods for applying dense and well-bonded metal coatings onto polymeric articles such as airframe components and, more particularly, to methods for coating at temperatures below the melting points of the materials that form the coatings and components.

### BACKGROUND

Cold gas-dynamic spraying (hereinafter “cold spraying”) is a technique that is sometimes employed to form coatings of various materials on a substrate. In general, a cold spraying system uses a pressurized carrier gas to accelerate particles through a supersonic nozzle and toward a targeted surface. The cold spraying process is referred to as a cold process because the particles are mixed and sprayed at a temperature that is well below their melting point, and the particles are near ambient temperature when they impact with the targeted surface. Converted kinetic energy, rather than a high particle temperature, causes the particles to plastically deform, which in turn causes the particles to form a bond with the targeted surface. Bonding to the component surface occurs as a solid state process with insufficient thermal energy to transition the solid powders to molten droplets. Cold spraying techniques can therefore produce a thermal or wear-resistant coating that strengthens and protects the component using a variety of materials that may not be easily applied using techniques that expose the materials and coatings to high temperatures.

A variety of different systems and implementations can be used to perform a cold spraying process. For example, U.S. Pat. No. 5,302,414, entitled “Gas-Dynamic Spraying Method for Applying a Coating” describes an apparatus designed to accelerate to supersonic speed materials having a particle size of between 5 to about 50 microns. The particles are sprayed from a nozzle at a velocity ranging between 300 and 1200 m/s. Heat is applied to the carrier gas to between about 300 and about 400° C., but expansion in the nozzle causes the spraying material to cool. The spraying material therefore returns to near ambient temperature by the time it reaches the targeted substrate surface.

When coating metal substrates, the sprayed particles impinge on the targeted substrate surface and the impact breaks up any oxide films on the particle and substrate surfaces as the particles bond to the substrate. Thus, cold spraying techniques prevent unwanted oxidation of the substrate or powder, and thereby produce a cleaner coating than many other processes. Such techniques also enable the formation of non-equilibrium coatings. More specifically, since the sprayed materials are not heated or otherwise caused to react with each other or with the substrate, coatings can be produced that are not producible using other techniques.

In contrast to cold spraying, thermal spraying processes include heating methods to bring at least some of the spray material to a melting point prior to impacting the sprayed surface, thereby producing a strong and uniform coating. Some thermal spraying processes also utilize plasma to ionize the sprayed materials or to assist in changing the sprayed materials from solid phase to liquid or gas phase. Melted spraying particles produce liquid splats that land on a targeted substrate surface and bond thereto. Some thermal spraying techniques only supply sufficient heat to melt a fraction of the spraying material particles, and consequently only cause surface melting to occur.

Thermal spraying is not a viable method for applying coatings of alloys having relatively high melting temperatures to many substrates since the high temperature liquid or particles may react with or disrupt the substrate surface and perhaps lower its strength. For example, plastic and other polymeric materials typically have relatively low melting temperatures when compared to metals, and would consequently melt and/or burn upon impact with molten metals. Cold spraying is sometimes a preferred spraying method for various substrates because it enables the sprayed materials to bond with such substrates at a relatively low temperature. The coating materials that are sprayed using the cold gas-dynamic spraying process typically only incur a net gain of about 100° C. with respect to the ambient temperature. Plastic deformation facilitates bonding of sprayed particles to the substrate. Further, since the sprayed particles are kept well below their melting temperatures, they are not very susceptible to oxidation or other reactions.

The family of polymers covers a wide range of materials, although most polymers are generally lightweight. Polymers are often easily formable by various processes, and consequently may be used to manufacture complex shapes. Some polymer materials have somewhat low strength, although many have strengths comparable to aluminum, and others such as carbon composites are very strong and rigid. As previously mentioned, however, polymers commonly have low melting temperatures and consequently may deform, burn, or be otherwise damaged by exposure to temperatures far below the melting points of many metals. Further, although many polymers are strong and rigid, many are not very wear resistant. These limitations reduce the usefulness of polymers for applications in some high technology applications such as in the aerospace field. Although polymers may be useful structural materials for some airframe components, they have limited utility in areas that are close to an engine, a heat exchanger, or an auxiliary power unit. Further, polymers have limited utility as materials for noise suppression or vibration damping components because there is often a likelihood exposure to erosion-promoting elements and/or to damaging heat.

The composite family also covers a wide range of materials. Some such as carbon/carbon and silicon/silicon carbide are fiber reinforced and have exceptionally high strengths. Composites made from Spectra™ fiber fabricated by Honeywell International, Inc. also have expansive utility as structural materials in some high technology applications. However, utility is somewhat limited for composites since many have poor erosion or temperature capabilities.

Hence, there is a need for low cost methods of protecting substrates made from polymeric materials in order to enhance the wear-resistance, and usefulness of polymeric components in high temperature environments. There is also a need for a method that is capable of efficiently and cost-effectively producing a wear and temperature-resistant coating for polymeric components. There is also a need for a spraying method by which such coatings may be uniformly and thoroughly applied at temperatures well below their melting points.

### BRIEF SUMMARY

The present invention provides a method for forming a continuous metal coating on a polymeric component surface with a metallic coating. The method includes the step of cold gas dynamic spraying a metal powder having a first average particle diameter directly onto the polymeric component surface at a first particle velocity sufficient to cause the metal powder to micropenetrate the polymeric component surface and also form the continuous metal coating thereon.

The present invention also provides a method for coating a polymeric component surface with a heat shielding metal layer. The method includes the steps of cold gas-dynamic spraying a first metal powder onto the polymeric component surface to form a bonding layer, and then cold gas-dynamic spraying a second metal powder onto the bonding layer to form the heat shielding metal layer at a thickness of at least 5.1 mils.

The present invention also provides a method for coating a polymeric component surface with a wear and erosion resistance metal layer. The method includes the step of cold gas-dynamic spraying a powder mixture onto the polymeric component surface to form the wear and erosion resistance metal layer, the mixture comprising at least one metal powder and at least one hard particle powder.

The present invention also provides a method for forming a continuous metal coating on a component surface formed from a non-metallic composite material. The method includes the step of cold gas dynamic spraying a metal powder directly onto the component surface to form the continuous metal coating thereon.

Other independent features and advantages of the preferred methods will become apparent from the following detailed description, taken in conjunction with the accompanying drawing which illustrates, by way of example, the principles of the invention.

### BRIEF DESCRIPTION OF THE DRAWING

FIG. 1 is a schematic view of a cold spraying apparatus;

FIG. 2 is a block diagram depicting an exemplary method of cold spraying a metal coating onto a polymeric substrate;

FIG. 3A is a 30× microscopic image of a cold sprayed aluminum/aluminum oxide coating formed on a polycarbonate substrate;

FIG. 3B is a 200× microscopic image of the coating depicted in FIG. 3A; and

FIG. 4 is a 300× microscopic image of a partial coating of aluminum on a polycarbonate substrate.

### DETAILED DESCRIPTION OF A PREFERRED EMBODIMENT

The following detailed description of the invention is merely exemplary in nature and is not intended to limit the invention or the application and uses of the invention. Furthermore, there is no intention to be bound by any theory presented in the preceding background of the invention or the following detailed description of the invention.

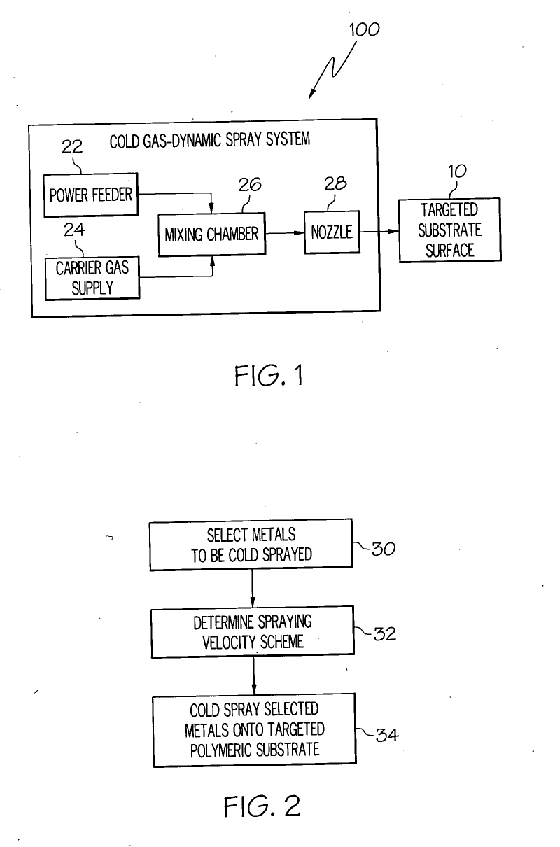

Turning now to FIG. 1, an exemplary cold spraying system 100 is illustrated diagrammatically. The system 100 is illustrated as a general scheme, and additional features and components can be implemented into the system 100 as necessary. The main components of the cold spraying system 100 include a powder feeder 22 for providing powder materials, a carrier gas supply 24, a mixing chamber 26 and a convergent-divergent nozzle 28.

In general, the system 100 transports the metal powder mixtures with a suitable pressurized gas to the mixing chamber 26. The particles are accelerated by the pressurized carrier gas through the specially designed supersonic nozzle 28. Exemplary carrier gases include air, helium and nitrogen. When the powder particles are accelerated toward the nozzle 28, the carrier gas is typically heated to about 300 to 400° C. The nozzle 28 directs the accelerated powder particles toward a targeted surface 10 to form a dense and uniform coating. Due to expansion in the nozzle, the powder particles are close to ambient temperature when they impact with the targeted surface 10. If the particles reach a critical velocity, which is specific to each type of powder, the impact will cause any oxide films on the particles to break up. Further, the kinetic energy associated with the impact causes plastic deformation of the particles, and further causes the particles to bond to the targeted surface 10.

Because the cold spraying system 100 is useful for depositing coatings at temperatures far below the sprayed material melting point, cold spraying may be a uniquely capable process for forming coatings on polymeric and components and composite materials as heat shields and/or environmental barriers that promote wear and erosion resistance. Thermoplastic materials are an exemplary set of polymers on which metal coatings may be formed by cold spraying. Polycarbonates are just one type of suitable thermoplastic material. Exemplary polycarbonate substrates include any in the family of Lexan™ polycarbonate thermoplastic resins. Such resins are amorphous engineering thermoplastics with high mechanical, optical, electrical and thermal properties. They may include a variety of additives, including UV stabilizers, mold release agents, flame retardants, and glass materials as structural reinforcement additives. Other suitable polymers include polytetrafluoroethylene (teflon™), nylon, polyoxymethylene (acetal), polysulfone, polyphenylene, and polyamide. Fiber-reinforced composites are an exemplary set of non-metallic composite materials on which metal coatings may be formed by cold spraying. Exemplary fiber-reinforced composite materials include Kevlar™, and Spectra™ fibers. Fibers of Kevlar™ include long molecular chains produced from poly-paraphenylene terephthalamide. Spectra™ fibers include strands of polyethylene with tetrahedral-bonded carbon atoms that provide much higher strength and melting temperatures to the composition than standard polyethylene. Other exemplary composites include carbon fiber-reinforced composites, silicon/silicon carbide-reinforced composites, polytetrafluoroethylene fiber-reinforced composites. Various other particulate, discontinuous fiber, and continuous fiber composites may also be suitable substrates.

Metal coatings may be cold sprayed onto a polymeric component with varying thicknesses depending on the coating's intended purpose. Both thin and thick coatings may be adequately bonded to the component. Further, since bonding may be more effective between particular polymers and metals than others, the metal coatings may comprise a thin layer of an effective bonding metal formed directly on the polymer substrate, and at least one thicker metal layer formed on the thin bonding metal layer. The at least one thicker layer, and particularly the outermost thicker outer layer, has desired wear and erosion resistant properties to protect the polymer substrate.

One exemplary cold sprayed metal coating is formed directly on a polymeric component as a thick single layer. The thick metal coating functions as a heat shield. More particularly, the thick metal coating is capable of both reflecting and conducting external heat to protect the polymeric component from external high temperatures. An additional advantage is that the coating acts as an oxygen barrier that prevents the polymer from burning. An effective heat shield coating is cold sprayed is at least 5.1 mils (at least 130 micrometers). The thick metal coating is preferably formed directly on the polymeric component, although if necessary a single thin bonding layer may be formed between the thick metal coating and the polymeric component to promote mechanical and/or chemical bonding. According to other embodiments, the overall metal coating formed directly on the polymeric component is less than 2.0 mils (less than about 50 microns). For example, an oxidation (i.e. burning) and/or corrosion barrier may be sufficient at a thickness of less than 1.0 mil (less than about 25 microns).

There is a wide range of achievable particle velocities using a cold spray system. When coating a polymeric component surface with a metal, the carrier gas pressure may be adjusted as necessary to ensure that the polymer substrate is not eroded or otherwise damaged upon impact with the sprayed solid metal particles. For example, when spraying hard metals the carrier gas pressure may be reduced initially to a relatively low pressure until the metal forms a thin coating on the substrate. Once the thin coating is formed, the carrier gas pressure may be raised to a relatively high pressure to form the remainder of the metal coating on the polymer substrate.

In addition, soft metals may be selected over harder metals depending on the specific polymer substrate. For example, metals such as aluminum, copper, silver, zinc, and other relatively soft metals, and combinations of such metals, may be readily cold-sprayed onto most polymeric substrates at a velocity at which plastic deformation and bonding will occur without damage to the substrates. For other intermediate-hardness metals such as magnesium, iron, brass, bronze, nickel, titanium, and other medium-hardness metals, and combinations of such metals, it may be beneficial to reduce the carrier gas pressure so the metal only partially deforms upon impact with the polymer substrate. Alternatively, it may be beneficial to form a bonding layer of a soft metal and then to deposit a medium-hardness metal to avoid damage to the substrate. For hard metals such as chromium, steel, MCrAlY alloys, and various hard superalloys, a bonding layer may be necessary depending on the hardness of the polymer substrate.

An exemplary cold sprayed metal coating includes at least one pure metal or metal alloy and at least one kind of hard particles. The pure metal or metal alloy promotes heat conduction away from a hot zone, and also reflects external heat. The hard particles are included in the coating to improve wear and erosion resistance for the coated polymeric component. Preferred hard particles include alumina, (Al₂O₃), silica (SiO₂), silicon carbide (SiC). Other exemplary hard particles include tungsten carbide (WC), aluminum nitride (AlN), boron nitride (BN), boron carbide (B₄C), molybdenum carbide (MoC₂), titanium aluminum carbide (Ti₃AlC), titanium carbide (TiC), chrome carbide (Cr₃C₂), chromia (Cr₂O₃), titania (TiO₂), zirconia (Zr₂O₃), and hafnium carbide (HfC).

Turning now to FIG. 2, a block diagram depicts an exemplary method for coating a polymeric substrate with a metal. Starting with step 30, one or more metals are selected for spraying on a polymer substrate. The substrate may be a surface of any type of component. As previously mentioned, the coating method benefits polymeric components that are may be susceptible to heat-related damage and/or erosion due to high temperatures and environmental hazards. Exemplary polymeric components that may benefit from cold sprayed metal coatings include components included in aerospace and other high technology applications, although there are countless other applications for which the present invention may be beneficial. As another example, a thick coating may be useful to enhance rapid cooling of electronic components. The cold sprayed coating may be applied to areas on electronic components that are prone to overheating. A cold sprayed coating may also serve as a bond layer that may be low-temperature soldered to a fin structure or a heat exchanger in an electronic assembly.

The one or more metals are selected depending on the characteristics of the polymer substrate, and its intended use. For example, if a bonding layer is to be cold sprayed between the substrate and an outer layer, metals that are may be easily adhered to the substrate are selected for the bonding layer. In addition, one or more hard particles may be selected to be included to promote wear and erosion resistance. An exemplary spraying mixture may include a soft metal such as aluminum, along with hard particles such as aluminum oxide. The selected metals and any hard particles are combined to form a powder mixture. Mixing the metal powders may be performed using various hand or machine mixing methods.

Next, if the polymeric substrate is a soft material, or if the selected metal is especially hard, a spraying velocity scheme is designed as step 32 to avoid damage to the substrate surface. For example, the spraying velocity may be modified by increasing or reducing the carrier gas pressure so the sprayed metal particles collide onto the polymeric substrate without deforming it or otherwise causing component damage. Determinants such as the type of carrier gas and the particle size for the sprayed materials may affect the spraying velocity scheme. For example, although helium is a carrier gas capable of spraying relatively large particles at supersonic velocities sufficient to cause the large particles to plastically deform upon impact with a substrate surface, smaller metal particles can be sprayed at a sufficient velocity using helium at a lower pressure flow, or using cheaper carrier gases such as air and nitrogen. Also, the spraying velocity scheme may include initially spraying with the carrier gas at a low pressure until the metal forms a thin coating on the substrate. After the thin coating is formed, the carrier gas pressure may be raised to a relatively high pressure to form the remainder of the metal coating on the polymer substrate.

After selecting the one or more metal powders, the system 100 from FIG. 1 transports the metal with a suitable pressurized gas to the mixing chamber 26, and the mixture is accelerated by the pressurized carrier gas through the nozzle 28 toward a targeted surface 10 as step 34. The metal particles impact with the targeted surface with at least the initial impacting metals micropenetrating the polymer or composite surface, meaning that the particles slightly impact the substrate without causing the overall structure to deform or melt. The sprayed metals bond with the targeted surface and form a dense coating. Using the above method, a coating having a substantially uniform microstructure and composition is bonded to a polymeric substrate. The coating process may be performed without substantial surface preparation such as grit blasting or chemical treatments. A clean polymer substrate may be coated with a suitable metal without any substrate modification or adaptation.

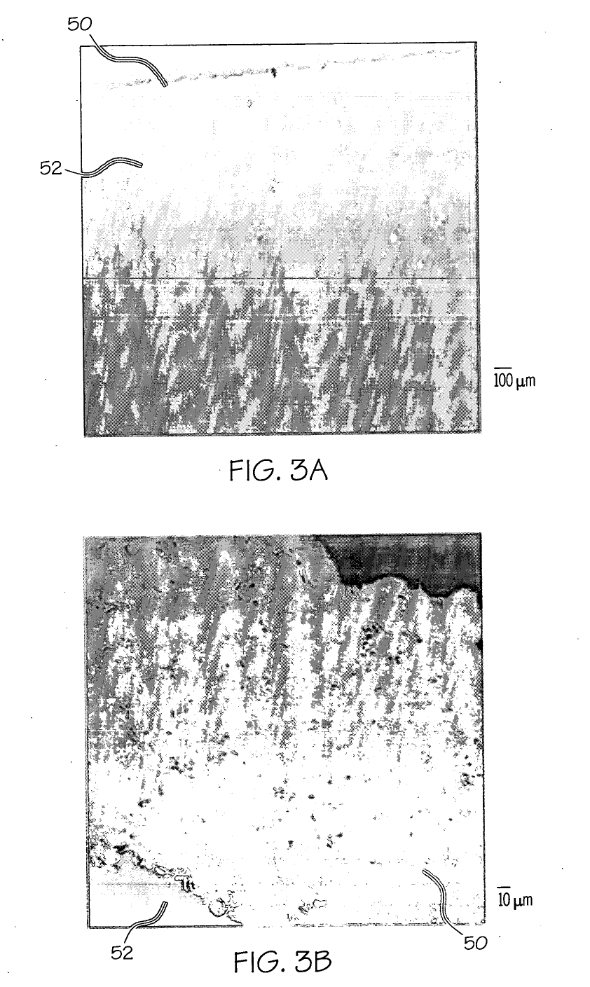

FIG. 3A is a 30× microscopic image of a cold sprayed aluminum coating 50 formed on a polycarbonate substrate 52, and FIG. 3B is a 200× microscopic image of the same coating depicted in FIG. 3A. As seen in the image, only one powder was deposited on the substrate 52 without any bond layer.

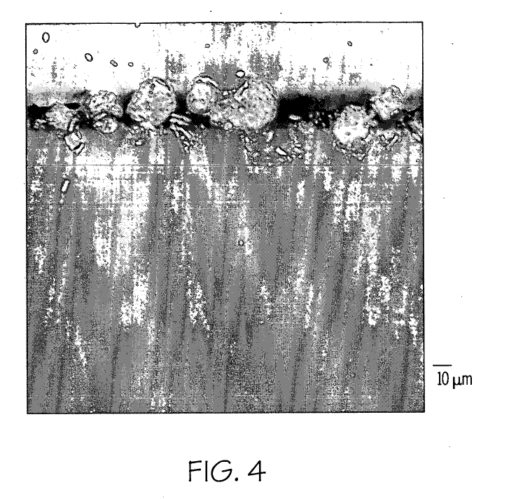

At low magnifications the interface between the coating 50 and the substrate 52 reveals a discrete boundary. At somewhat higher magnifications it is apparent that some penetration into the polymer has occurred. The degree of penetration apparently positively correlates with the sprayed powder particle size. A clearer image of cold sprayed metal penetrating a polymer substrate is depicted in FIG. 4, which is a 300× microscopic image of a partial coating of aluminum on a polycarbonate substrate after just one low velocity coating pass. The metal powder is penetrating the polymer and the particles are mechanically held in place. Subsequent passes, which may be performed at higher velocities, cause the newly-sprayed powder to deform and metallurgically bond to the powder held in the polymer. The previously-sprayed powder will also be deformed laterally by the newly-sprayed powder, forming a thick and uniform coating. Images at even higher magnifications further reveal the complexities of the mechanical interlocking between the coating and the polymer, resulting in a strong bond.

The kinetic energy associated with the impacting sprayed metal powder may potentially cause minor substrate and/or powder surface melting to occur. However, the images in FIGS. 3 to 4 do not reveal any substantial chemical bonding between the polycarbonate and the sprayed metals that would be indicative of surface melting. While there is potential for some chemical bonding between the polymer and the metal to occur, it is apparent from the images in the figures that the bonding is substantially mechanical.

FIG. 4 also reveals larger metal powder particles bond more strongly to the polymer substrate than do smaller metal powder particles. Thus, an exemplary cold spraying method includes initially spraying metal powders having a relatively large particle size, followed by spraying metal powders having a relatively small particle size. For example, cold sprayed metal powders may initially have an average particle size of greater than 50 microns in order to create an initial deep bond zone, and the subsequently sprayed metal powder may have an average particle size in the range 5 to 50 microns.

The cold spraying method of the present invention therefore provides a strong mechanically-bonded metal coating on polymer components. Such components may be used in demanding applications because the bond is capable of withstanding numerous thermal cycles without debonding. High conductivity metals such as aluminum and copper may therefore be used as coating metals without having to consider factors such matching the thermal expansion coefficient of the metal to the polymer, or building up transition layers to reduce the impact of thermal expansion mismatches. Similarly, the bond is sufficiently strong for hard wear and erosion resistant coatings to be deposited without a likelihood for debonding to occur during use due to mechanical forces on the coating.

While the invention has been described with reference to a preferred embodiment, it will be understood by those skilled in the art that various changes may be made and equivalents may be substituted for elements thereof without departing from the scope of the invention. In addition, many modifications may be made to adapt to a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A method for forming a dense and continuous metal coating on a polymeric component surface of a polymeric component, the method comprising:
cold gas dynamic spraying a metal powder having a first average particle diameter directly onto the polymeric component surface at a first particle velocity sufficient to cause the metal powder to micropenetrate the polymeric component surface and also form the dense and continuous metal coating thereon to protect the polymeric component.

2. The method of claim 1, further comprising:
cold gas dynamic spraying a metal powder having a second average particle size that is smaller than the first average particle size as part of the dense and continuous metal coating, after spraying the metal powder having the first average particle size.

3. The method of claim 2, wherein the metal powder having the second average particle size is sprayed at a second particle velocity that is higher than the first particle velocity to ensure deformation and bonding of the metal powder.

4. The method according to claim 1, wherein the dense and continuous metal coating formed directly on the polymeric component substrate is a heat shielding metal layer having a thickness of at least 5.1 mils.

5. The method according to claim 1, wherein the dense and continuous metal coating formed directly on the polymeric component substrate has a thickness of less than 2.0 mils.

6. The method according to claim 1, wherein the polymeric component surface is selected from the group consisting of a polycarbonate, polytetrafluoroethylene, nylon, polyoxymethylene, polysulfone, polyphenylene, and polyamide.

7. The method according to claim 1, wherein the metal powder comprises at least one metal selected from the group consisting of aluminum, copper, silver, zinc, magnesium, iron, brass, bronze, nickel, and titanium.

8. A method for coating a polymeric component surface of a polymeric component with a heat shielding metal layer, the method comprising:
cold gas-dynamic spraying a first metal powder onto the polymeric component surface to form a bonding layer;
cold gas-dynamic spraying a second metal powder onto the bonding layer to form the heat shielding metal layer at a thickness of at least 5.1 mils, the heat shielding metal layer protecting the polymeric component from external high temperatures.

9. The method according to claim 8, wherein the polymeric component surface comprises at least one polymer selected from the group consisting of a polycarbonate, polytetrafluoroethylene, nylon, polyoxymethylene, polysulfone, polyphenylene, and polyamide.

10. The method according to claim 8, wherein at least the first metal powder comprises at least one soft metal selected from the group consisting of aluminum, copper, silver, zinc.

11. The method according to claim 8, wherein the second metal powder comprises at least one intermediate hardness metal selected from the group consisting of magnesium, iron, brass, bronze, nickel, titanium, chromium, steel, and MCrAlY alloys wherein M is a metal.

12. A method for coating a polymeric component surface of a polymeric component with a dense and uniform wear and erosion resistance metal layer, the method comprising:
cold gas-dynamic spraying a powder mixture onto the polymeric component surface to form the dense and uniform wear and erosion resistance metal layer that protects the polymeric component, the mixture comprising at least one metal powder and at least one hard particle powder.

13. The method according to claim 12, wherein the polymeric component surface comprises at least one polymer selected from the group consisting of polycarbonate, polytetrafluoroethylene, nylon, polyoxymethylene, polysulfone, polyphenylene, and polyamide.

14. The method according to claim 12, wherein the metal powder comprises at least one soft metal selected from the group consisting of aluminum, copper, silver, zinc, magnesium, iron, brass, bronze, nickel, and titanium.

15. The method according to claim 12, wherein the at least one hard particles is selected from the group consisting of aluminum oxide, silica, silicon carbide, tungsten carbide, aluminum nitride, boron nitride, boron carbide, molybdenum carbide, titanium aluminum carbide, titanium carbide, chrome carbide, chromia, titania, zirconia, and hafnium carbide.

16. A method for forming a dense and continuous metal coating on a component surface formed from a non-metallic composite material, the method comprising:
cold gas dynamic spraying a metal powder directly onto the component surface to form the continuous metal coating thereon.

17. The method according to claim 16, wherein the non-metallic composite material is a fiber-reinforced composite material.

18. The method according to claim 17, wherein the fiber-reinforced composite material is selected from the group consisting of poly-paraphenylene terephthalamide fiber-reinforced composites, polyethylene with tetrahedral-bonded carbon fiber reinforced composites, carbon fiber-reinforced composites, silicon/silicon carbide fiber reinforced composites, and polytetrafluoroethylene fiber-reinforced composites.

19. The method according to claim 16, wherein the metal powder comprises at least one metal selected from the group consisting of aluminum, copper, silver, zinc, magnesium, iron, brass, bronze, nickel, titanium, chromium, steel, and MCrAlY alloys wherein M is a metal.

20. The method according to claim 16, wherein the metal powder further comprises at least one hard particle powder mixed therein that is wear and erosion resistant.
